(19) United States
(12) Patent Application Publication
(10) Pub. No.: US 2005/0054471 A1
(43) Pub. Date: Mar. 10, 2005

(54) Drive axle assembly and differential

(76) Inventor: Yakov Fleytman, Lake Orion, MI (US)

Correspondence Address: YAKOV FLEYTMAN, 3233 HICKORY DRIVE, LAKE ORION, MI, 48359, US

(21) Appl. No.: 10/657,430

(22) Filed: Sep. 8, 2003

(51) Int. Cl. F16H 48/06

(52) U.S. Cl. 475/226

(57) ABSTRACT

A drive axle assembly and differential is provided with an enveloping worm placed into engagement with a face gear. The enveloping worm face gears are used for drive axle assembly or a small differential while reducing the noise and the weight of the assembly.

### FIELD OF THE INVENTION

The present invention relates generally to vehicle driveline systems, and more particularly, to an axle assembly having a worm gearset and a traction control. This type of the axle assembles could be used in front drive axle, rear drive axle or power take-off unit.

### BACKGROUND OF THE INVENTION

Drive axle assemble is used in various vehicular driveline applications for transferring rotary power from an input to a pair of outputs while permitting speed differentiation between the outputs. For example, in rear-wheel drive vehicles, the rear axle assembly includes a final drive differential unit having a carrier and a gearset connecting the carrier to left and right axle shafts. As is conventional, a hypoid gearset is used to transfer power from the propshaft to the carrier. The hypoid gearset includes a bevel-type ring gear secured to the carrier and a beveled pinion meshed with the ring gear and driven by the propshaft. The size of the ring gear and the number of teeth associated with both the ring gear and pinion are selected to provide a predetermined speed reduction between the propshaft and the carrier. However, the size of the ring gear greatly dictates the packaging requirements for the differential housing of the axle assembly.

Worm gearsets, otherwise referred to as worm/worm gear transmissions, are known in the mechanical power transmission field. The worm gear is driven by the rotation of the worm with which it meshes. The rotational speed of the associated shaft of the worm gear is a function of the number of teeth on the worm gear and the number of threads on the worm. The worm may be single or multiple threaded. Standard enveloping worm/worm gear transmissions have been used in drive axle only for ratios of five and more (U.S. Pat. No. 1,980,237 by Trbojevich). Due to such high ratios, it has been considered impractical to use the worm gear as the driven member and the worm as the driving member to transfer power from the worm gear to the worm in power take-of unit. In my U.S. Pat. No. 6,098,480 tooth surface of a worm gear having a first worm gear pressure angle and a second worm gear pressure angle. Said first worm gear pressure angle is twice said second worm gear pressure angler. Worm gear with this profile has high contact stress and very poor lubrication condition. Most efficient and practical use of enveloping worm in power train applications is drive axle assemble with enveloping worm described in my U.S. Pat. No. 6,537,174 and power take-off unit described in my U.S. Pat. No. 6,523,430. For higher ratios, more than 1:5 enveloping worm in mesh with enveloping type worm gear loses efficiency. Also, the distance between axis of enveloping worm rotation and axis of worm gear rotation can not allow to use above described enveloping worm in mesh with enveloping type worm gear in existing design, by substituting spiral bevel or hypoid gears. Spiral bevel gears have zero offset and hypoid gear set compared to worm drive also has very small offset.

### SUMMARY OF THE INVENTION

Accordingly, it is an object of the present invention to provide a drive axle assembly equipped with an enveloping worm gearset and a traction unit that is smaller than standard drive axle assembly and differential. Also, since said enveloping worm having a thread less than one revolution is positioned in mesh with said worm gear it creates suction for better lubrication. It becomes more likely due to asymmetrical profile of the enveloping worm. (Standard enveloping worm always has a symmetrical design). Combination of enveloping worm having the thread less than one revolution with a housing leads to production of stream of a cooling liquid (oil). Enveloping worm works like a screw pump. The housing helps to separate low-pressure oil from high-pressure oil, which increases liquid flow through teeth mesh.

It is a further object of the present invention to provide a drive axle assembly equipped with a differential that is lighter in weight and quieter in operation compared to conventional differentials.

These and other objects of the present invention are obtained by providing a drive axle assembly with a unique enveloping worm face gearset. In particular, a drive shaft having an enveloping-type worm mounted thereto is meshed with a face type worm gear, which is fixed to an input member of the traction unit or differential, where face worm gear teeth having a tooth surface is generated by a profile of the enveloping worm.

Preferably, the face type worm gear is secured to a carrier of the differential. The housing supports the differential including pinion gears, which are meshed with side gears, with each side gear secured to corresponding left and right axle shafts. Enveloping worm face gear transmissions have not been known. Thus, those skilled in the art did not consider enveloping type worm gears in mesh with a face type worm gear to be feasible for commercial applications. In contrast, the enveloping face worm gears of the present invention utilize a worm gear that is easily manufactured.

Rolling motion with small percentage of sliding motion significantly increases efficiency of drive axle assemble. For the same size, this invention has almost twice the torque capacity of traditional hypoid gearing. Suction teeth action makes excellent teeth lubrication that also reduces heat. It allows different casting designs from not very heat conductive material, even from plastic or ceramic. As compared to prior spiral bevel or hypoid gear drive axle assemble, enveloping worm face drive axle assemble is more compact, quiet and efficient. Thus, the present invention can replace hypoid or bevel drive axles in many vehicle power train applications.

In the present invention, the enveloping worm can be with less than one revolution of threads, which can have only one supporting shaft. Further areas of applicability of the present invention will become apparent from the comprehensive description provided hereinafter. It should be understood however that the detailed description and specific examples, while indicating preferred embodiments of the invention, are intended for purposes of illustration only, since various changes and modifications within the spirit and scope of the invention will become apparent to those skilled in the art from this complete description.

### BRIEF DESCRIPTION OF THE DRAWINGS

The present invention will become more fully understood from the detailed described below:

FIG. 1 is a view of a design with enveloping worm placed in the middle of the face of worm gear with enveloping worm having less than 180 degrees of revolution of threads.

FIG. 2 is an isometric view of a design with enveloping worm placed in the middle of the face of worm gear with enveloping worm having less than 180 degree of revolution of threads.

FIG. 3 is a view of a design with an enveloping worm placed on the face of worm gear with offset and with enveloping worm having 90 degrees of revolution of a thread.

FIG. 4 is an isometric view of a design with an enveloping worm placed on the face of worm gear with offset and with enveloping worm having 90 degrees of revolution of threads.

FIG. 5 is a view of a design with 180 degree of thread revolution of an enveloping worm placed on the face of a worm gear.

FIG. 6 is an isometric view of a design with 180 degree of thread revolution of an enveloping worm placed on the face of a worm gear.

FIG. 7 is a view of a design with an enveloping worm gear transmission with less than 90 degrees between worm axis and face worm gear axis according to the principles of the present invention.

FIG. 8 is an isometric view of a design with an enveloping worm gear transmission with less than 90 degrees between worm axis and face worm gear axis according to the principles of the present invention.

FIG. 9 is an isometric view of a design with thread with less than one revolution of an enveloping worm placed on the face of a worm gear.

FIG. 10 is an isometric view of drive axle assemble where face gear of enveloping worm face transmission is attached to a carrier of a differential.

FIG. 11 is an isometric view of an enveloping worm differential.

FIG. 12 is an isometric view of an enveloping worm pinion.

FIG. 13 is an isometric view of drive axle assembles in a four wheel drive system.

FIG. 14 is a cross-section of housing with bearing support and an enveloping worm face gears with a ring gear attached to a traction unit.

FIG. 15 is an isometric view of a four wheel drive system where an axle assemble of enveloping worm face gears is used as a power take-off unit.

FIG. 16 is a schematic view of a drive axle assembles where ring gear of enveloping worm face transmission is attached to a traction unit having two sets of clutches.

FIG. 17 shows the difference between spiral bevel or hypoid gears and enveloping worm face.

### DETAILED DESCRIPTION OF THE PREFERRED EMBODIMENTS

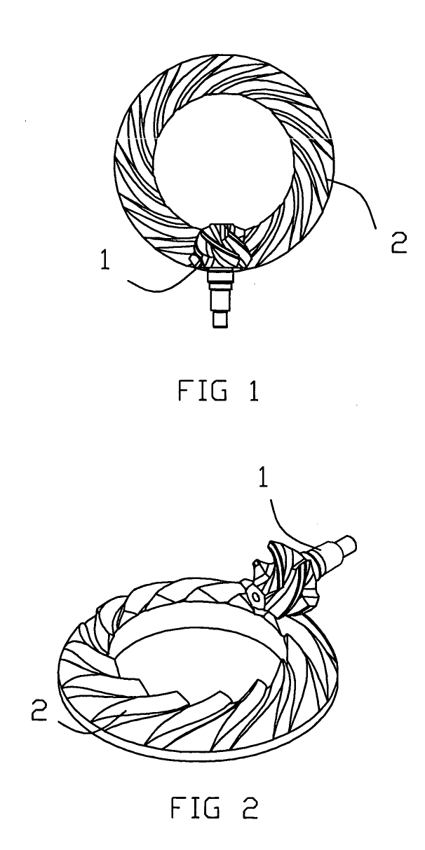

As will be detailed, a drive axle assembly with a unique worm-type input gearset embodying the principles of the present invention will be described below with reference to FIGS. 1 through 17. Initially, however, the following discussion provides a detailed description of the enveloping worm face gear transmissions used for the worm-type-input gearset. Prior to specific consideration of the drawings, several unique features of the present invention can be discussed. In particular, the present invention is directed to gearsets having an enveloping worm face gear, where an enveloping worm is paced in mesh with a face gear. This type of gear produces contact pattern along the gear tooth line: from the left to the right or from the right to the left depending on the direction of rotation. This motion of contact pattern is very different from motion of contact pattern of any gears, used in drive axle assemble. For example in hypoid or spiral bevel gears contact pattern in motion is across the gear tooth: from the root to the tip or from the tip to the root depending on the direction of rotation.

Usually, face gear has straight side worm engagement in mesh with a face (ring) gear. The reason for using an enveloping worm is more torque capacity. A computer model simulation can be utilized to generate the configuration of the enveloping worm and gear teeth of the face gear. Then gears could be machined by using multi-tasking turning center or special machine, like machines that are widely used for spiral bevel or hypoid gear production.

Referring now to the drawings.

FIG. 1 is a view of a design with enveloping worm 1 placed in the middle of the face of worm gear 2 with enveloping worm threads having less than 180 degrees of revolution. FIG. 2 is an isometric view of a design with enveloping worm 1 placed in the middle of the face of worm gear 2 with enveloping worm threads having less than 180 degrees of revolution.

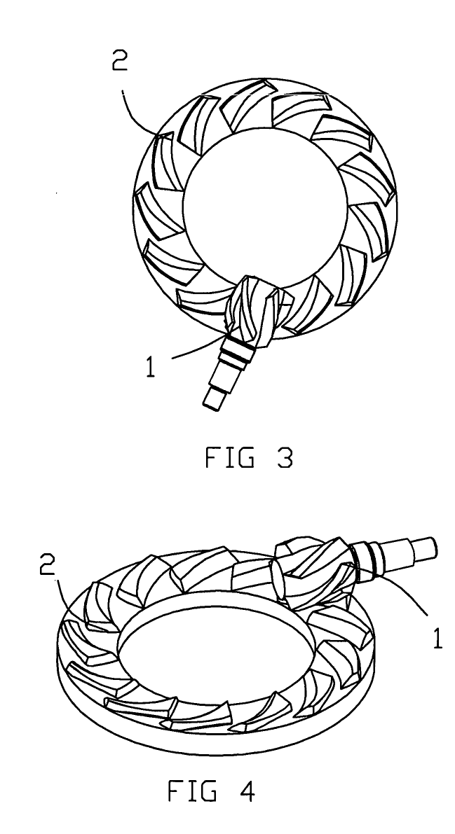

FIG. 3 is a view of a design with an enveloping worm 1 placed on the face of worm gear 2 with offset and with enveloping worm threads having 90 degrees of revolution.

FIG. 4 is an isometric view of a design with an enveloping worm 1 placed on the face of worm gear 2 with offset and with enveloping worm threads having 90 degree of revolution.

FIG. 5 is a view of a design with 180 degree of thread revolution of an enveloping worm 1 placed on the face of worm gear 2.

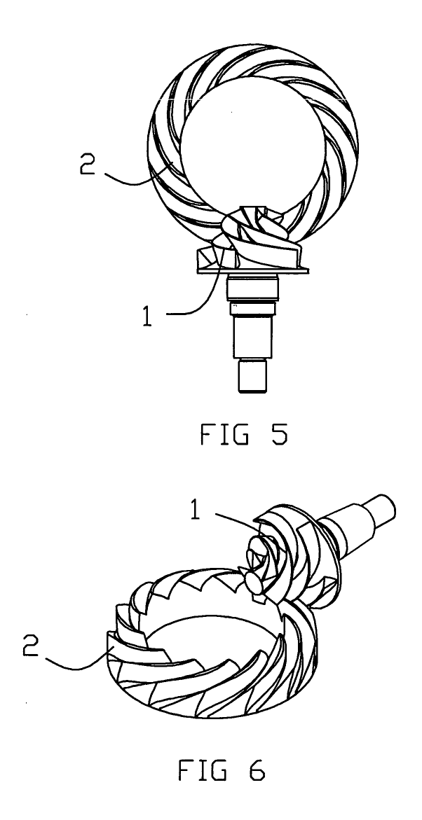

FIG. 6 is an isometric view of a design with 180 degrees of thread revolution of an enveloping worm 1 placed on the face of worm gear 2.

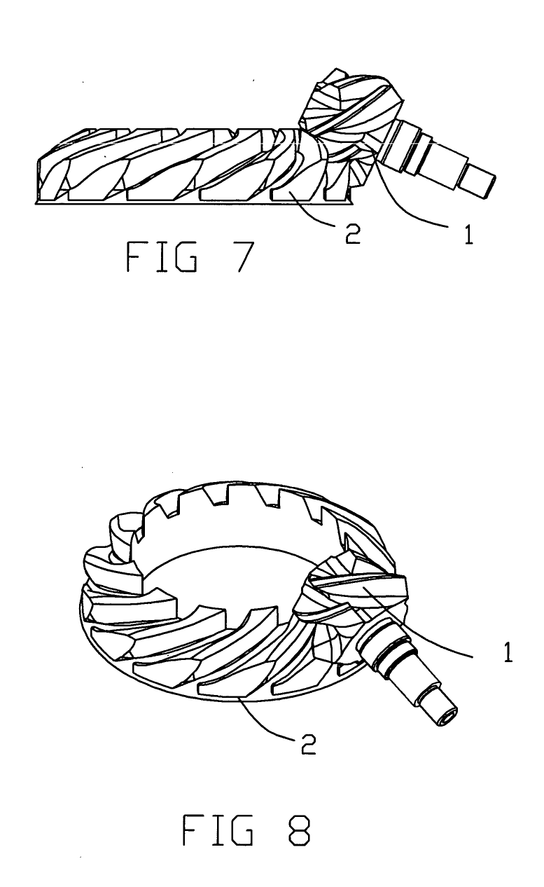

FIG. 7 is a view of a design with an enveloping worm gear transmission with less than 90 degrees between enveloping worm 1 axis and face worm gear 2 axis according to the principles of the present invention;

FIG. 8 is an isometric view of a design with an enveloping worm gear transmission with less than 90 degrees between enveloping worm 1 axis and face worm gear 2 axis according to the principles of the present invention;

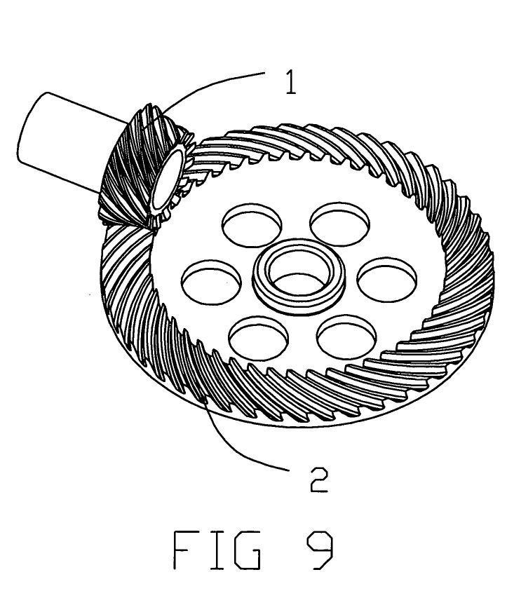

FIG. 9 is an isometric view of a design with thread less than one revolution of an enveloping worm 1 placed on the face of a worm gear 2, where worm 1 has 15 threads and face gear 2 has 46 teeth.

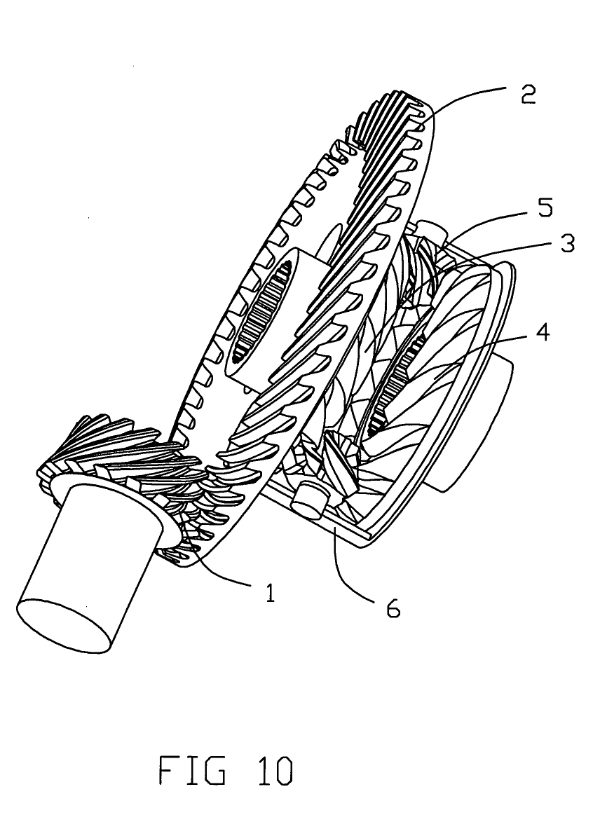

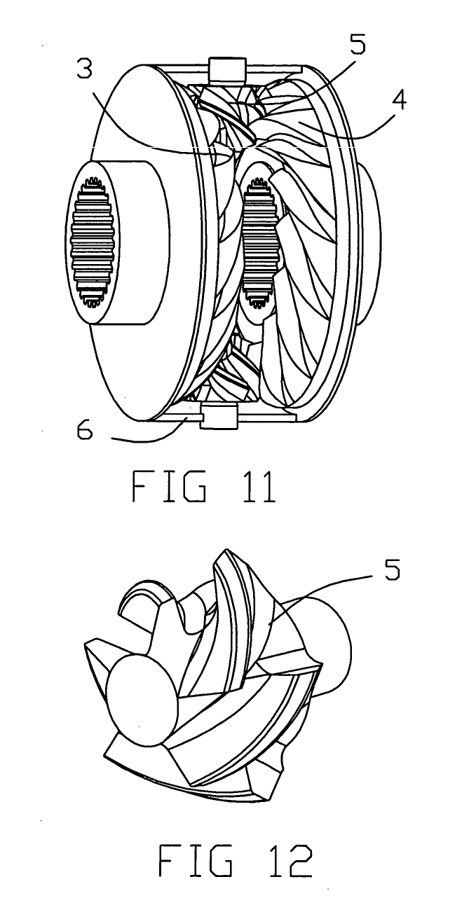

FIG. 10 is isometric view of a drive axle assemble according with present invention. Enveloping worm pinion 1 is in meshing engagement with a face type gear 2. Face gear 2 is attached to a traction unit, having two members for connection to axle shafts. Traction unit is gear differential having side face gears 3 and 4 for connection to axle shafts in mesh with intermediate enveloping worms 5 rotatably located on a carrier 6, and said carrier 6 attached to said face type gear 2. Gear differential could be any gear differential like bevel gear differential or planetary spur gear differential. More preferable, gear differential that has enveloping worms and face gears is shown in FIG. 11. Enveloping worm 5 shown in FIG. 12 has shortened threads, compared to enveloping worm pinion in FIGS. 1-9. These short threads reduce contact ratio to a number a little bit more than 1 compared to contact ratio of more than 2 on FIGS. 1-9. Profile of enveloping threads is wide open and in combination with tapered nature of enveloping worm allows producing worm 5 by very productive technology: forging or near-net casting.

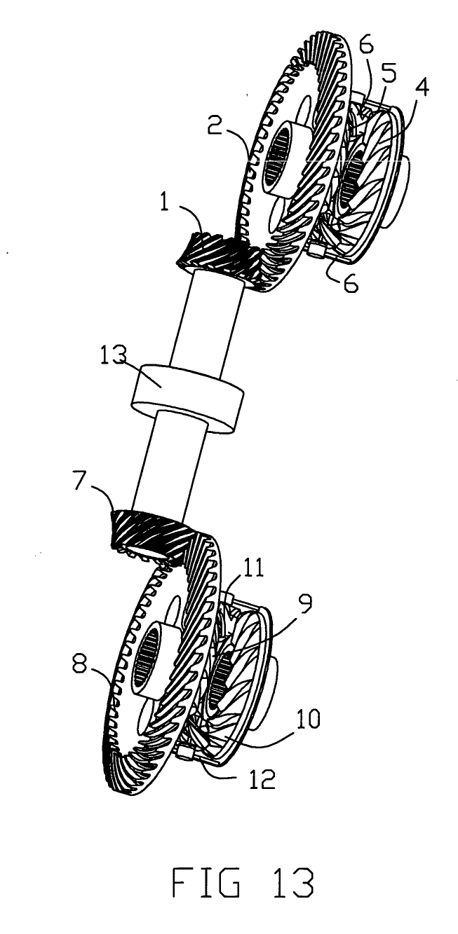

FIG. 13 is isometric view of a drive axle assemble for four drive axle vehicle system. We are using for example enveloping worm face gears for power take—of unit and for rear drive axles. However we can use combinations of enveloping worm face gear drive axle assembles and spiral or bevel gear drive axle assembles for placing it on front or rear drive axles. FIG. 13 has an additional drive axle assemble with enveloping worm pinion 7 linked to said enveloping worm 1. Linked, means that enveloping worm 1 and enveloping worm 2 may have direct connection or more preferable this connection is established by special traction system like central differential.

Additional drive axle assemble is comprised of second enveloping worm pinion 7 in meshing engagement with a second face type gear 8 and a second gear traction unit adapted for connection to said second face gear 8. Second traction unit has two members for connection to axle shafts where this traction unit has side face gears 9 and 10 for connection to axle shafts in mesh with intermediate enveloping worms 11 rotatably located on a carrier 12. Said carrier 12 is attached to said face type gear 8. Enveloping worms 1 and 7 are linked to each other by traction device 13 like coupling or central differential.

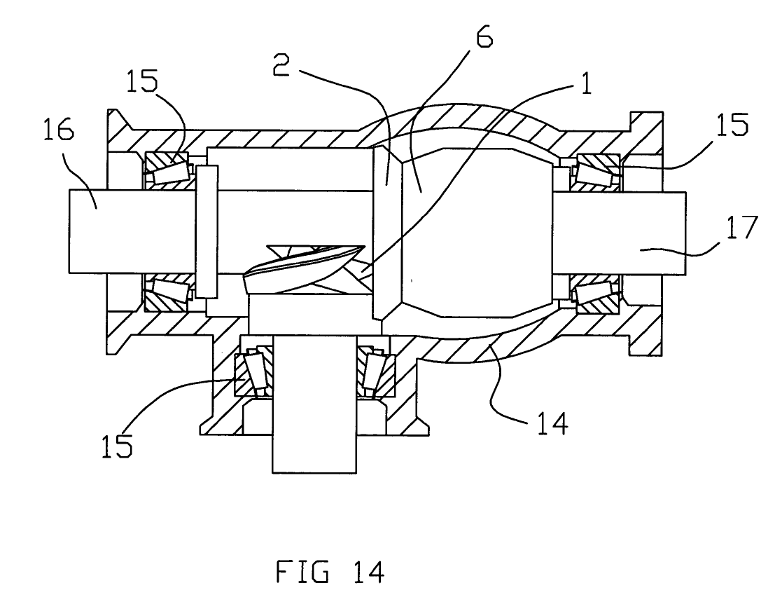

FIG. 14 is an isometric view of enveloping worm pinion 1 in meshing engagement with a face type gear 2 located in housing 14 having bearing 15 for support gears 1 and 2. Face gear 2 is attached to traction unit 6 which has two members for connection to axle shafts 16 and 17. If drive axle assemble from FIG. 14 will be used in rear or front drive axles, input power will go to enveloping worm pinion 1. To use drive axle assemble in power take-off unit, input power will go to face gear 2 and output will be from enveloping pinion 1.

The enveloping worm thread has a rolling action contact relationship with the teeth of the face gear, which provides an increased efficiency. In the present application, it is a surface-to-surface contact between the enveloping worm gear teeth and the face gear that increases the torque capacity of the drive axle assemble. For back drive, that is usually used in power take-off unit where the face gear is a driven member and the enveloping worm is a driving member, this drive axle assemble also has high efficiency compared to a hypoid gear set.

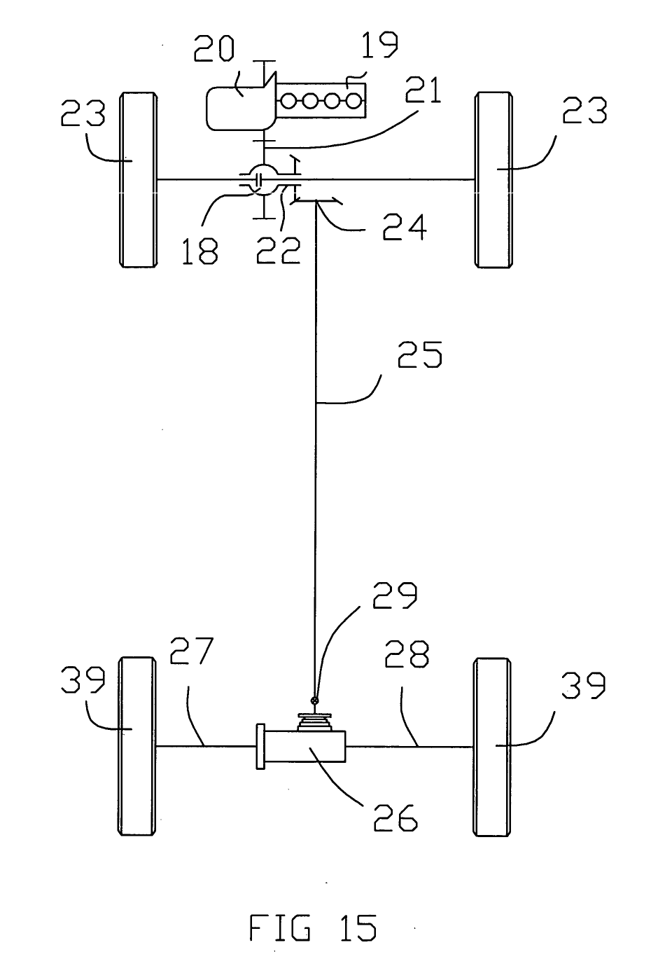

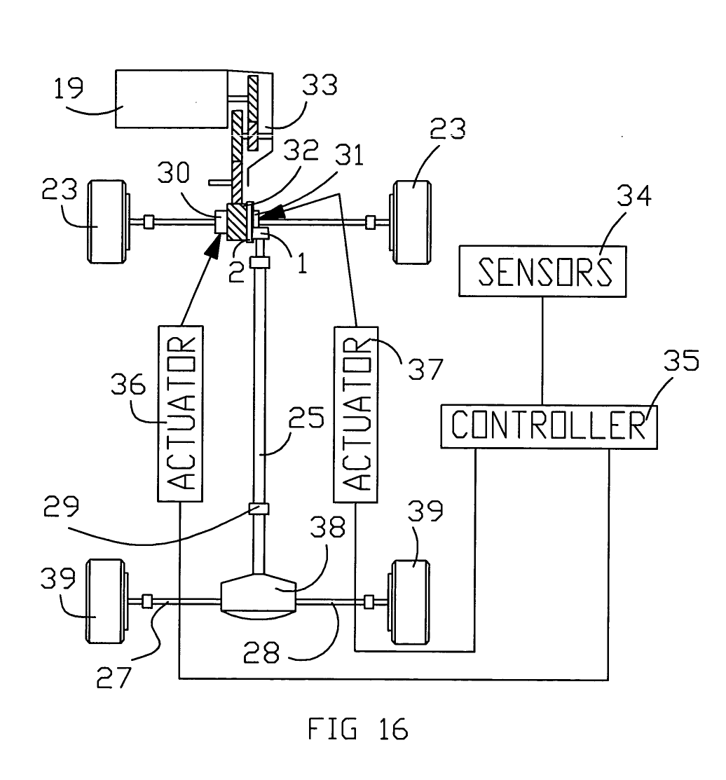

The lower noise of the enveloping worm face gear drive axle assemble compared to hypoid and bevel axel drive assembles make using the present invention more beneficial in motor vehicle powertrain applications. For the same size, this invention can provide more than twice the capacity of hypoid gearing. The less number of teeth of the present invention than in a hypoid gear of the same circumference makes each tooth thicker and therefore stronger. The enveloping worm face gear drive axle assemble, as described above, can be utilized as an input gearset to any differential of the type usually used in a drive axle assembly, as is shown and described with reference to FIGS. 15 and 16. It should be understood that the particular drive train arrangement shown in FIGS. 15 and 16 is merely exemplary of but one system to which the present invention can be applied. In particular, a drive axle assembly of the present invention equipped with differential 18 as shown as part of a vehicle drive train which includes an engine 19 and a transmission 20. The output of transmission 20 drives by gears 21 a front differential 18 with carrier 22. Differential 18 delivers rotary power to front wheels 23 and facilitates speed differentiation there, while output gear 24 of drive axle assemble mates with a rear drive axle 26, with two outputs connected to rear half shafts 27 and 28. Propeller shaft 25 is connected through at least one universal joint 29 to rear drive axle assembly 26. In FIG. 16 said traction unit has two sets of clutches; each clutch has first members 30 and 31 for connection to axle shafts and second member 32 attached to said face type gear 2. Output of transmission 33 is connected to said face gear 2. When a vehicle is in motion sensors 34 generate signals of the road condition, relative speed of tires, and same specific factors, like acceleration of the vehicle. Processor 35 by actuators 36 and 37 changes maximum allowable torque between first members 30, 31 and second members 32 of clutches. Clutches can be any physical nature, like friction type or electromagnetic type.

Output torque from pinion 1 transferes to rear differential 38. If rear differential is differential shown in FIG. 11 its side gears 3, 4 are each attached to a corresponding one of left and right axle shaft 28 and 29 that are also rotatably supported by carrier 6. Left and right axle shafts 27 and 28 are each connected to a corresponding one pair of rear wheels 39.

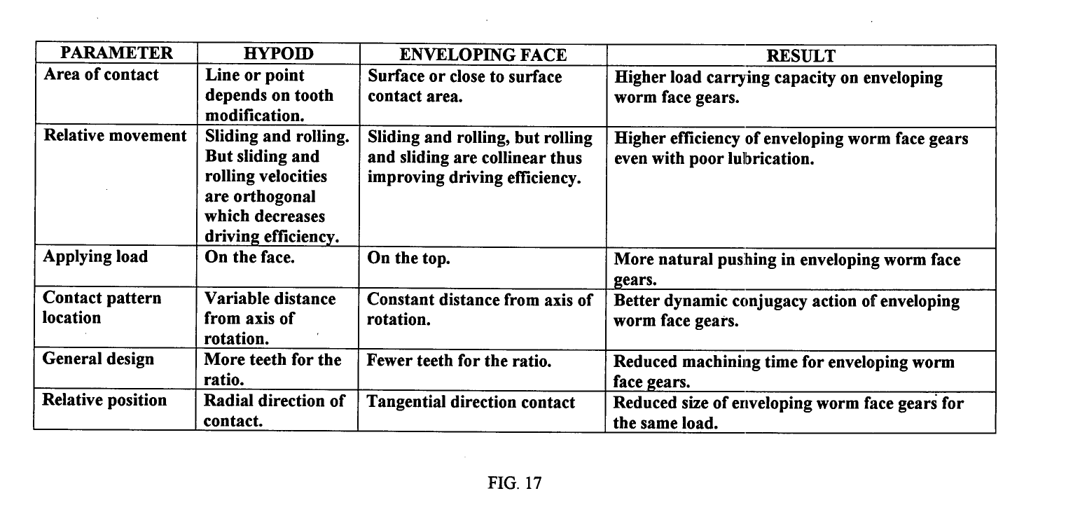

As seen, differential from FIG. 11 was utilized as part of the final drive assembly in a drive axle. However, differential from FIG. 11 could be used in place of front differential such that face gear 2 could be secured to carrier 6 with the enveloping worm pinion thereof secured to an output of transmission 20. In this arrangement, enveloping worm face gearset would replace a traditional ring gear and pinion arrangement associated with transaxles. Similarly, worm gearset of enveloping worm 1 and face gear 2 could be used in place of power take-off gearing. In such applications face gear will be input gear and output enveloping pinion linked to rear drive axle. They will transfer motion in the back drive direction. In some application differential from FIG. 11 could be replace by standard bevel gear differential or different type of differentials, like locking or friction clutch differentials. We can see the differences between spiral bevel or hypoid gears and enveloping worm face gears in the FIG. 17.

### Advantages of Drive Axle Assemble

Transmit More Power with Smaller Gears.

Compact alternative for driver axle assembles with hypoid and spiral bevel gears. Enveloping worm face gears have high torque capacity due to surface to surface contact mesh that reduces contact stresses.

In automotive power train applications like front and rear drive axles, power take-off units it saves up to 30% of space and significantly reduces weight.

Efficiency is Extremely High

Hypoid and spiral bevel gears are have always been used in the drive axle assembles, but enveloping worm face drive axle assemble is more efficient. It has higher percentage of rolling/sliding motion and excellent dynamic lubrication. It has extending life even without lubrication.

Lower Noise

Each thread of the pinion most of the time is in mesh with two teeth. It reduces impact of engagement and disengagement, increases the contact ratio and makes quieter motion.

Manufacturability

Using existing spiral bevel or hypoid gear cutting machines can make enveloping worm face drive axle assemble not more expensive than hypoid or spiral bevel gears. For some configuration, forging technology or power metallurgy could be applied as well.

Several embodiments of the present invention have been disclosed. A worker of ordinary skill in the art would recognize that certain modifications would come within the scope of this invention. In the invention being thus described, it will be obvious that the same may be varied in many ways. Such variations are not to be regarded, as a departure from the spirit and scope of the invention, and all such modifications as would be obvious to one skilled in the art are intended to be included within the scope of the following claims.

1. Drive axle assemble comprising:
an enveloping worm pinion in meshing engagement with a face type gear;
a housing with bearing support;
a traction unit adapted for connection to said face gear, having two members for connection to axle shafts.

2. Drive axle assemble as recited in claim 1 wherein said enveloping worm pinion having threads with less than one revolution.

3. Drive axle assemble as recited in claim 1 wherein said traction unit is gear differential having side gears for connection to axle shafts in mesh with intermediate gears rotatably located on a carrier, and said carrier attached to said face type gear.

4. Drive axle assemble as recited in claim 1 wherein said traction unit has two sets of clutches, each clutch has first member and second member attached to said face type gear.

5. Drive axle assemble comprising:
a first enveloping worm pinion in meshing engagement with a first face type gear;
a first housing with bearing support;
a first traction unit adapted for connection to said first face gear, have two members for connection to axle shafts;
an additional drive axle assemble with pinion linked to said enveloping worm.

6. Drive axle assemble as recited in claim 5 wherein said additional drive axle assemble comprising:
a second enveloping worm pinion in meshing engagement with a second face type gear;
a second housing with bearing support;
a second traction unit adapted for connection to said second face gear, having two members for connection to axle shafts.

7. Drive axle assemble as recited in claim 5 wherein said enveloping worm pinion has threads with less than one revolution.

8. Drive axle assemble as recited in claim 5 wherein said additional drive axle assemble comprising:
a bevel type pinion in meshing engagement with a ring gear;
an additional housing for said additional pinion with bearing support;
an additional traction unit adapted for connection to said additional face type gear, having two members for connection to axle shafts.

9. Drive axle assemble as recited in claim 5 wherein said traction unit is gear differential with side gears for connection to axle shafts in mesh with intermediate gears rotatably located on a carrier, and said carrier attached to said face type gear.

10. Drive axle assemble as recited in claim 5 wherein said traction unit has two sets of clutches, each clutch has first member for connection to axle shafts and second member attached to said face type gear.

11. A worm differential for drive axle assemble, comprising:
a differential case;
a carrier;
two said face gears opposing each other, providing traction torque;
intermediate enveloping worms in mesh with said face gears rotatably located on said carrier.

12. A worm differential for drive axle assemble as recited in claim 11 wherein said enveloping worms have threads with less than one revolution.

13. A worm differential for drive axle assemble as recited in claim 12 wherein said enveloping worms have threads with less than 90 degree of revolution.
